(19) United States
(12) Patent Application Publication
(10) Pub. No.: US 2007/0287041 A1
(43) Pub. Date: Dec. 13, 2007

(54) System level adjustments for increasing stack inlet RH

(76) Inventors: Abdullah B. Alp, West Henrietta, NY (US); David A. Arthur, Honeoye Falls, NY (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/449,933

(22) Filed: Jun. 9, 2006

(51) Int. Cl. H01M 8/04

(52) U.S. Cl. 429/22; 429/26; 429/25

(57) ABSTRACT

A control system for a fuel cell stack that maintains the relative humidity of the cathode inlet air above a predetermined percentage by doing one or more of decreasing stack cooling fluid temperature, increasing cathode pressure, and/or decreasing the cathode stoichiometry when necessary to increase the relative humidity of the cathode exhaust gas that is used by a water vapor transfer device to humidify the cathode inlet air. The control system can also limit the power output of the stack to keep the relative humidity of the cathode inlet air above the predetermined percentage.

### BACKGROUND OF THE INVENTION

1. Field of the Invention

This invention relates generally to a system and method for controlling the relative humidity of the cathode inlet air to a fuel cell stack and, more particularly, to a system and method for controlling the relative humidity of the cathode inlet air to a fuel cell stack that includes selectively decreasing stack coolant temperature, increasing cathode pressure, decreasing cathode stoichiometry and/or limiting power output of the stack.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

Excessive stack temperatures may damage the membranes and other materials in the stack. Fuel cell systems therefore employ a thermal sub-system to control the temperature of the fuel cell stack. Particularly, a cooling fluid is pumped through the cooling fluid flow channels in the bipolar plates in the stack to draw away stack waste heat. During normal fuel cell stack operation, the speed of the pump is controlled based on the stack load, the ambient temperature and other factors, so that the operating temperature of the stack is maintained at an optimal temperature, for example 80° C. A radiator is typically provided in a coolant loop outside of the stack that cools the cooling fluid heated by the stack where the cooled cooling fluid is cycled back through the stack.

As is well understood in the art, fuel cell membranes operate with a certain relative humidity (RH) so that the ionic resistance across the membrane is low enough to effectively conduct protons. The relative humidity of the cathode outlet gas from the fuel cell stack is controlled to control the relative humidity of the membranes by controlling several stack operating parameters, such as stack pressure, temperature, cathode stoichiometry and the relative humidity of the cathode air into the stack. For stack durability purposes, it is desirable to minimize the number of relative humidity cycles of the membrane because cycling between RH extremes has been shown to severely limit membrane life. Membrane RH cycling causes the membrane to expand and contract as a result of the absorption of water and subsequent drying. This expansion and contraction of the membrane causes pin holes in the membrane, which create hydrogen and oxygen cross-over through the membrane creating hot spots that further increase the size of the hole in the membrane, thus reducing its life.

During operation of the fuel cell, moisture from the MEAs and external humidification may enter the anode and cathode flow channels. At low cell power demands, typically below 0.2 A/cm², the water may accumulate within the flow channels because the flow rate of the reactant gas is too low to force the water out of the channels. As the water accumulates, droplets form in the flow channels. As the size of the droplets increases, the flow channel is closed off, and the reactant gas is diverted to other flow channels because the channels are in parallel between common inlet and outlet manifolds. As the droplet size increases, surface tension of the droplet may become stronger than the delta pressure trying to push the droplets to the exhaust manifold so the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

As mentioned above, water is generated as a by-product of the stack operation. Therefore, the cathode exhaust gas from the stack will include water vapor and liquid water. It is known in the art to use a water vapor transfer (WVT) unit to capture some of the water in the cathode exhaust gas, and use the water to humidify the cathode input airflow. WVT devices tend to be rather expensive and occupy a large amount of space in fuel cell system designs. Therefore, minimizing the size of the WVT device will not only decrease the cost of the system, but also decrease the space that is needed for it to be packaged in. Further, the known WVT devices tend to degrade over time. Particularly, as the membranes or other components in the device age, their water transport capability decreases, thus decreasing their overall efficiency.

Further, when the power request for the stack increases, the compressor speed increases to provide the proper amount of cathode air for the requested power. However, when the compressor speed increases, the flow of air through the WVT device has a higher speed, and less of a chance of being humidified to the desired level. Also, in some fuel cell system designs, the relative humidity of the cathode exhaust gas stream is maintained substantially constant, typically around 80%, where the temperature of the cooling fluid flow is controlled so that its temperature increases as the load on the stack increases.

### SUMMARY OF THE INVENTION

In accordance with the teachings of the present invention, a control system for a fuel cell stack is disclosed that maintains the relative humidity of the cathode inlet air above a predetermined percentage by performing one or more of decreasing the stack cooling fluid temperature, increasing the cathode pressure, and/or decreasing the cathode stoichiometry when necessary to increase the relative humidity of the cathode exhaust gas that is used by a water vapor transfer device to humidify the cathode inlet air. The control system can also limit the power output of the stack to keep the relative humidity of the cathode inlet air above the predetermined percentage.

Additional features of the present invention will become apparent from the following description and appended claims, taken in conjunction with the accompanying drawings.

### BRIEF DESCRIPTION OF THE DRAWING

FIG. 1 is a schematic block diagram of a fuel cell system including a controller for controlling cathode inlet humidity, according to an embodiment of the present invention.

### DETAILED DESCRIPTION OF THE EMBODIMENTS

The following discussion of the embodiments of the invention directed to a control system for a fuel cell stack that maintains the cathode inlet air relative humidity above a predetermined value by doing one or more of decreasing the stack cooling fluid temperature, increasing the cathode pressure, decreasing the cathode stoichiometry and/or limiting the power output of the stack when necessary is merely exemplary in nature and is in no way intended to limit the invention or its applications or uses.

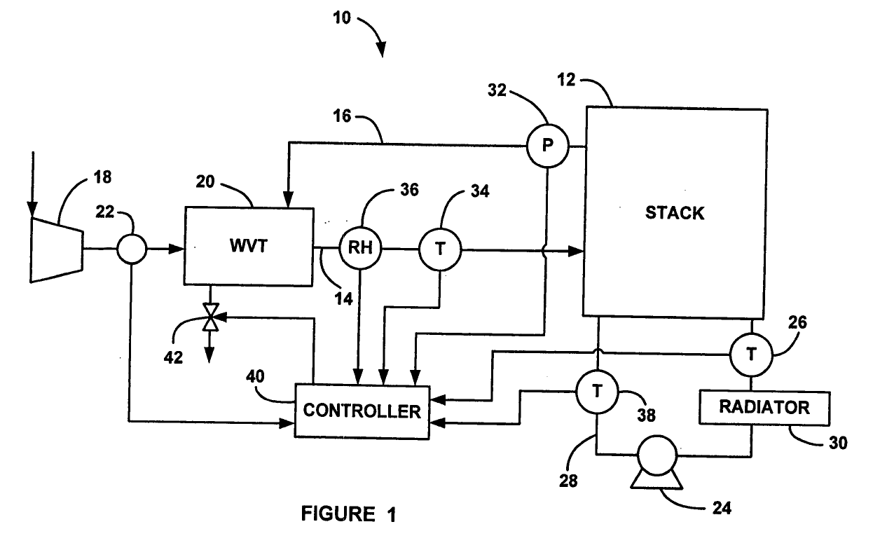

FIG. 1 is a schematic block diagram of a fuel cell system 10 including a fuel cell stack 12. The stack 12 includes a cathode input line 14 and a cathode output line 16.. A compressor 18 generates a flow of air for the cathode side of the stack 12 that is sent through a WVT device 20 to be humidified. A mass flow meter 22 measures the flow rate of the air from the compressor. The humidified air is input into the stack 12 on the line 14, and humidified cathode exhaust gas is provided on the output line 16. The cathode exhaust gas on the line 16 is sent through the WVT device 20 to provide the water vapor for humidifying the cathode input air. The WVT device 20 can be any suitable WVT device for the purposes described herein.

The system 10 includes a pump 24 that pumps a cooling fluid through a coolant loop 28 that flows through a stack 12. The heated cooling fluid from the stack 12 is sent through a radiator 30 where it is cooled to be returned to the stack 12 through the coolant loop 28. The system 10 also includes a backpressure valve 42 positioned in the cathode exhaust gas line 14 after the WVT device 20 for controlling the pressure of the cathode side of the stack 12.

The system 10 includes several sensors for sensing certain operating parameters. Particularly, the system 10 includes an RH sensor 36 for measuring the relative humidity of the cathode inlet air in the line 14, and a temperature sensor 34 for measuring the temperature of the cathode inlet air in the line 14. It is known in the art to use a dew point sensor instead of the combination of the RH sensor 36 and the temperature sensor 34. A temperature sensor 38 measures the temperature of the cooling fluid in the coolant loop 28 entering the stack 12, and a temperature sensor 26 measures the temperature of the cooling fluid exiting the stack 12. A pressure sensor 32 measures the pressure of the cathode exhaust gas in the line 16. As is known in the art, the measured relative humidity of the cathode inlet air needs to be corrected because the temperature of the stack 12 is different than the temperature of the air in the inlet line 14. By knowing the inlet RH and the temperature of the cooling fluid entering the stack 12, the corrected relative humidity of the cathode air can be calculated.

A controller 40 receives the mass flow signal from the mass flow meter 22, the relative humidity signal from the RH sensor 36, the temperature signal from the temperature sensor 34, the temperature signal from the temperature sensor 38, the temperature signal from the temperature sensor 26 and the pressure signal from the pressure sensor 32. The controller 40 also controls the backpressure valve 42.

According to the invention, the controller 40 attempts to maintain the corrected relative humidity above a predetermined percentage by performing one or more of decreasing the cooling fluid temperature, increasing the cathode pressure, and/or decreasing the cathode stoichiometry when necessary to increase the relative humidity of the cathode exhaust gas that is used by the WVT device 20 to humidify the cathode inlet air. The controller 40 can also limit the power output of the stack 12 to keep the relative humidity of the cathode inlet air above the predetermined percentage.

The controller 40 may decrease the stack cooling fluid temperature by increasing the speed of the pump 24 and/or the cooling ability of the radiator 28, such as by cooling fans. The controller 40 may increase or decrease the cathode pressure within the stack 12 by closing and opening the backpressure valve 42. The pressure sensor 32 will measure the change in the cathode pressure. Further, the controller 40 may decrease the cathode stoichiometry by decreasing the speed of the compressor 18 for a particular output current. The signal from the mass flow meter 22 is read by the controller 40 and based on this signal, the controller 40 controls the speed of the compressor 18 to the desired cathode stoichiometry set-point. The combination of one or more of these operations should increase the relative humidity of the cathode exhaust gas on the line 16, thus providing more humidity in the WVT device 20 for humidifying the cathode inlet air.

If one or more of these three operations does not increase the corrected relative humidity of the cathode inlet air above the desired percentage, then the controller 40 may limit the power output from the stack 12. This can be done by changing a “maximum current available” variable between the fuel cell stack 12 and the stack load. The value of the variable is decreased an appropriate amount until the cathode inlet humidification is sufficient. By reducing the variable, the stack load should draw less power, which reduces by-product water that could flood flow channels. Also, the cathode airflow set-point for the compressor 18 will decrease, resulting in a slower airflow through the WVT device 20, and more cathode inlet air humidification.

If the relative humidity of the cathode exhaust gas in the line 16 is increased to satisfy the inlet air relative humidity, then the output voltage of the fuel cells in the stack 12 are monitored to determine whether the cells may be flooded, especially the end cells. If there is an indication that water is accumulating in the flow channels, then the controller 40 can decrease the relative humidity of the cathode exhaust gas by any of the operations discussed above.

With this control design, it may be possible to reduce the size of the WVT device 20 over those typically used in the industry without sacrificing the minimum cathode inlet humidification needed for long stack life. Therefore, the cost, weight and space requirements required for the WVT device 20 can be reduced.

Equations are known in the art for calculating the cathode outlet relative humidity, the cathode stoichiometry and the cathode inlet RH for the control algorithm of the invention discussed above. Particularly, the cathode output relative humidity can be calculated by:

$$\frac{\frac{100 \cdot {P}_{1}}{[ {10}^{7.903 \frac{1674.5}{229.15 + {T}_{1}}} ] [ CS + 0.21 ] ( 1 - \frac{{10}^{7.903 \frac{1674.5}{229.15 + {T}_{1}}}}{{P}_{1} + {P}_{2}} )}}{[ 2 \cdot 0.21 ] + [ ( \frac{{10}^{7.903 - \frac{1674.5}{229.15 + {T}_{1}}}}{{P}_{1} + {P}_{2}} ) ( CS - 2 \cdot 0.21 ) ]} \qquad ( 1 )$$

The cathode stoichiometry can be calculated by:

$$\frac{Air\_mass \_flow [ g / s ]}{4.33 \cdot [ \frac{Cell\_Count \cdot Stack\_Current [ amps ]}{( 1.6022 \cdot {10}^{- 19} ) ( 6.022 \cdot {10}^{23} )} ] [ \frac{1}{4} ] \cdot 2 \cdot 15.9994} \qquad ( 2 )$$

The cathode inlet relative humidity percentage can be calculated by:

$$\frac{{10}^{7.093 \frac{1674.5}{229.15 + {T}_{2} [ C ]}}}{{10}^{7.093 \frac{1674.5}{229.15 + {T}_{3} [ C ]}}} \qquad ( 3 )$$

Where CS is the cathode stoichiometry, T₁ is the stack cooling fluid outlet temperature in degrees Celcius, P₁ is the cathode outlet pressure in kPa, T₂ is the cathode inlet temperature in degrees Celcius, P₂ is the cathode pressure drop in kPa, which is calculated based on a known model, and T₃ is the stack cooling fluid inlet temperature in degrees Celcius.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack receiving a cathode inlet airflow and outputting a cathode exhaust gas flow;
a compressor for providing the cathode inlet airflow to the stack;
a water vapor transfer device receiving the cathode inlet air flow from the compressor and the cathode exhaust gas flow from the fuel cell stack, said water vapor transfer device using water vapor in the cathode exhaust gas to humidify the cathode inlet air;
a coolant loop for flowing a cooling fluid through the stack to control stack temperature; and
a controller for controlling the relative humidity of the cathode inlet air so that the relative humidity does not fall below a predetermined percentage, said controller performing one or more of decreasing the temperature of the cooling fluid, increasing the cathode pressure, and decreasing the cathode stoichiometry to increase the relative humidity of the cathode exhaust gas to prevent the relative humidity of the cathode inlet air from falling below the predetermined percentage.

2. The system according to claim 1 wherein the controller increases the cooling fluid flow through the coolant loop to decrease the stack cooling fluid temperature.

3. The system according to claim 1 wherein the controller increases the cooling capability of a radiator in the coolant loop to decrease the stack cooling fluid temperature.

4. The system according to claim 1 further comprising a backpressure valve positioned within a cathode exhaust line, said controller closing the backpressure valve to increase the cathode pressure.

5. The system according to claim 1 wherein the controller decreases the speed of the compressor to decrease the cathode stoichiometry.

6. The system according to claim 1 wherein the controller limits fuel cell stack power output if none of decreasing the temperature of the cooling fluid, increasing cathode pressure, and decreasing cathode stoichiometry is effective in preventing the relative humidity of the cathode inlet air from falling below the predetermined percentage.

7. The system according to claim 1 further comprising a temperature sensor for measuring the temperature of the cooling fluid out of the stack and pressure sensor for measuring the cathode exhaust pressure, said controller calculating the cathode exhaust gas relative humidity by the equation:
$$\frac{\frac{100 * P 127}{[ {10}^{7.903 \frac{1674.5}{229.15 + {T}_{1}}} ] [ CS + 0.21 ] ( 1 - \frac{{10}^{7.903 \frac{1674.5}{229.15 + {T}_{1}}}}{{P}_{1} + {P}_{2}} )}}{[ 2 \cdot 0.21 ] + [ ( \frac{{10}^{7.903 - \frac{1674.5}{229.15 + {T}_{1}}}}{{P}_{1} + {P}_{2}} ) ( CS - 2 \cdot 0.21 ) ]}$$
where T₁ is the stack cooling fluid outlet temperature, P₁ is the cathode exhaust pressure, and P₂ is a cathode pressure drop.

8. The system according to claim 1 further comprising a mass flow meter for measuring the flow rate of the cathode inlet air, said controller calculating the cathode stoichiometry by the equation:
$$\frac{Air\_mass \_flow [ g / s ]}{4.33 \cdot [ \frac{Cell\_Count \cdot Stack\_Current [ amps ]}{( 1.6022 \cdot {10}^{- 19} ) ( 6.022 \cdot {10}^{23} )} ] [ \frac{1}{4} ] \cdot 2 \cdot 15.9994}$$

9. The system according to claim 1 further comprising a first temperature sensor for measuring the temperature of the cathode inlet air and a second temperature sensor for measuring the temperature of the cooling fluid out of the stack, said controller calculating the cathode inlet relative humidity percentage by the equation:
$$\frac{{10}^{7.093 \frac{1674.5}{229.15 + {T}_{2} [ C ]}}}{{10}^{7.093 \frac{1674.5}{229.15 + {T}_{3} [ C ]}}}$$
where T₂ is the cathode inlet temperature and T₃ is the cooling fluid out temperature.

10. The system according to claim 1 wherein the system is on a vehicle.

11. A fuel cell system comprising:
a fuel cell stack receiving a cathode inlet air flow and outputting a cathode exhaust gas flow;
a backpressure valve positioned in a cathode exhaust line;
a compressor for providing the cathode inlet airflow to the stack;
a water vapor transfer device receiving the cathode inlet airflow from the compressor and the cathode exhaust gas flow from the fuel cell stack, said water vapor transfer device using water vapor in the cathode exhaust gas to humidify the cathode inlet air;
a cooling fluid loop for flowing a cooling fluid through the stack to control stack temperature; and
a controller for controlling the relative humidity of the cathode inlet air so that relative humidity does not fall below a predetermined percentage, said controller increasing the relative humidity of the cathode exhaust gas to prevent the relative humidity of the cathode inlet air from falling below the predetermined percentage by performing one or more of increasing a cooling fluid flow to decrease the cooling fluid temperature, increasing the cooling capability of a radiator in order to decrease the cooling fluid temperature, increasing the cathode pressure by closing the backpressure valve, and decreasing the speed of the compressor to decrease the cathode stoichiometry.

12. The system according to claim 11 wherein the controller limits fuel cell stack power output if none of decreasing the temperature of the cooling fluid, increasing cathode pressure, and decreasing cathode stoichiometry is effective in preventing the relative humidity of the cathode inlet air from falling below the predetermined percentage.

13. The system according to claim 11 further comprising a temperature sensor for measuring the temperature of the cooling fluid out of the stack and a pressure sensor for measuring the cathode exhaust pressure, said controller calculating the cathode exhaust gas relative humidity by the equation:
$$\frac{\frac{100 * P 127}{[ {10}^{7.903 \frac{1674.5}{229.15 + {T}_{1}}} ] [ CS + 0.21 ] ( 1 - \frac{{10}^{7.903 \frac{1674.5}{229.15 + {T}_{1}}}}{{P}_{1} + {P}_{2}} )}}{[ 2 \cdot 0.21 ] + [ ( \frac{{10}^{7.903 - \frac{1674.5}{229.15 + {T}_{1}}}}{{P}_{1} + {P}_{2}} ) ( CS - 2 \cdot 0.21 ) ]}$$
where T₁ is the stack cooling fluid outlet temperature, P₁ is the cathode outlet pressure, and P₂ is a cathode pressure drop.

14. The system according to claim 11 further comprising a mass flow meter for measuring the flow rate of the cathode inlet air, said controller calculating the cathode stoichiometry by the equation:
$$\frac{Air\_mass \_flow [ g / s ]}{4.33 \cdot [ \frac{Cell\_Count \cdot Stack\_Current [ amps ]}{( 1.6022 \cdot {10}^{- 19} ) ( 6.022 \cdot {10}^{23} )} ] [ \frac{1}{4} ] \cdot 2 \cdot 15.9994}$$

15. The system according to claim 11 further comprising a first temperature sensor for measuring the temperature of the cathode inlet air and a second temperature sensor for measuring the temperature of the cooling fluid out of the stack, said controller calculating the cathode inlet relative humidity percentage by the equation:
$$\frac{{10}^{7.093 \frac{1674.5}{229.15 + {T}_{2} [ C ]}}}{{10}^{7.093 \frac{1674.5}{229.15 + {T}_{3} [ C ]}}}$$
where T₂ is the cathode inlet temperature and T₃ is the cooling fluid out temperature.

16. A method for preventing the relative humidity of a cathode inlet airflow to a fuel cell stack from falling below a predetermined percentage, said method comprising:
flowing a cathode exhaust gas through a water vapor transfer device;
flowing the cathode inlet airflow through the water vapor transfer device to pick up humidity provided by the cathode exhaust gas; and
performing one or more of decreasing the temperature of a cooling fluid that cools the stack, increasing the cathode pressure of the stack and decreasing the cathode stoichiometry to increase the relative humidity of the cathode exhaust gas to prevent the relative humidity of the cathode inlet air from falling below the predetermined percentage.

17. The method according to claim 16 further comprising limiting fuel cell stack power to prevent the relative humidity of the cathode inlet air from falling below the predetermined percentage.

18. The method according to claim 16 wherein decreasing the temperature of a cooling fluid includes increases the cooling fluid flow.

19. The method according to claim 16 wherein decreasing the temperature of a cooling fluid includes increasing the cooling capability of a radiator.

20. The method according to claim 16 wherein increasing the cathode pressure includes closing a backpressure valve in a cathode exhaust gas line.

21. The method according to claim 16 wherein decreasing the cathode stoichiometry includes decreasing the speed of a compressor that provides the cathode inlet airflow or increasing the output current of the stack.
